(19) United States
(12) Patent Application Publication
(10) Pub. No.: US 2012/0269360 A1
(43) Pub. Date: Oct. 25, 2012

(54) Large Scale Participatory Entertainment Systems For Generating Music Or Other Ordered, Discernible Sounds And/Or Displays Sequentially Responsive To Movement Detected At Venue Seating

(76) Inventor: Daniel Patrick Burke, Oyster Bay, NY (US)

(21) Appl. No.: 13/452,777

(22) Filed: Apr. 20, 2012

Related U.S. Application Data
(60) Provisional application No. 61/477,503, filed on Apr. 20, 2011.

(51) Int. Cl. H04B 3/00; E04H 14/00; E04H 3/12

(52) U.S. Cl. 381/77; 52/8; 52/1

(57) ABSTRACT

The seats in a seating venue, e.g. a large sports stadium, are designated into a plurality of distinct sound triggers. Sensors detect predetermined movement of participants at the sound triggers and generate signals which are sent to a broadcast device which broadcasts different, predetermined sounds in response to signals received from different sound triggers. Groups of people at a large seating venue can move together to generate a single sound, e.g. a musical instrument sound. By coordinating the sequential movement of different sound triggers, musical compositions are broadcast.

### RELATED APPLICATION DATA

This application is a non-provisional application of U.S. provisional patent application No. 61/477,503 filed Apr. 20, 2011 and claims the benefit thereof.

Entertainment systems which allow hundreds, and preferably thousands, of participants actively working together in a sequential, coordinated, cooperative manner to create an audio broadcast, such as a musical performance, at a seating venue, such as a stadium, by moving a portion of a movable seat or by moving themselves in a detectable fashion.

### BACKGROUND OF THE INVENTION

People visit stadiums, arenas, concert halls and theaters for many types of entertainment, for example, to attend sporting events and concerts. It is popular for fans to cheer loudly during certain times of sporting events, for example when prompted to do so by a key player or stadium management. It is also popular for crowds to perform a “wave” where fans sitting adjacent to each other sequentially stand and/or raise their arms to form a changing visual image which appears to travel around the stadium. Such group activities result in loud crowd noise which is fairly unsophisticated. For a given fan participating in a wave, other then watching fans in adjacent seating areas, little mental effort is required to participate in a wave.

Some previously disclosed entertainment systems have monitored one or more audience members in a theater or other seating venue and altered the selection of pre-recorded movie segments or the sequence of those segments which are broadcast to the moviegoers based upon detected physical activity and/or a physical condition of audience members.

### SUMMARY OF THE INVENTION

The entertainment systems provide a new platform which allows unlimited creativity by organizers and participants, and importantly, encourages very large numbers of participants, e.g. hundreds or thousand of participants, to cooperate with each other in a coordinated, sequential fashion to create a musical (or other audio and/or video) broadcast.

Various embodiments provide large-scale entertainment systems wherein attendees at a seating venue become active participants in the creation of an entertaining broadcast, such as a musical composition comprising many different musical notes and/or musical instrument sounds, a short series of musical notes, or other sounds or visual displays which are broadcast to the participants. As used herein, the term “broadcast” is used to indicate the projection of sound and/or visual displays.

One embodiment allocates the seats of a large sports stadium into subgroups each referred to herein as a “sound trigger”. A “sound trigger” comprises at least one seat and preferably comprises a plurality of seats. A sound, for example a sound made by a musical instrument referred to herein as a “musical instrument sound”, is assigned to each “sound trigger”. Sensors are provided which detect movement of a portion of a movable seat or movement of a participant at a seat and generate a discrete signal. The systems include or are connected to at least one broadcast device which broadcasts the predetermined audio sounds and/or video displays corresponding to detection signals from each sound trigger. The detection of such movement, subject to pre-determined parameters, therefore triggers the sequential broadcast of distinct sounds. Coordination of the timing and sequence of the movement at different sound triggers directly results in the sequential generation of the corresponding sounds, e.g. a melody, which is broadcast to the participants.

Various embodiments comprise systems which provide large groups of people, e.g. hundreds or thousands of people, with new, healthy, interesting and creative ways to compete with each other. For example, at a university football game, fans for one team can compete against fans for the opposing team to determine which fans can coordinate their movement better. Each team comprises a plurality of sound triggers which preferably move in a coordinated, sequential fashion to generate the broadcast signals in the desired sequence. One or more judges may select a winning team based upon the fluidity of the melodies generated by the teams of fans or by other parameters including the length of time between detection signals within a subgroup (sound trigger), the length of time between detection signals from different sound triggers of the same team, or other parameters as described in further detail below.

### BRIEF DESCRIPTION OF THE DRAWINGS

FIG. 1 illustrates a schematic of one embodiment of the present invention.

FIG. 2 is a block diagram illustrating one layout of a broadcast system of the present invention.

FIG. 3 illustrates a stadium seat of one embodiment.

FIG. 4 illustrates a stadium seat of a second embodiment.

FIG. 5 illustrates a stadium seat of a third embodiment.

FIG. 6 is a flow chart of an algorithm used with an embodiment.

FIG. 7 is a flow chart of a second algorithm used with an embodiment.

### DETAILED DESCRIPTION

The present invention provides participatory entertainment systems and components therefore which generate sequential discernible sounds and/or visual displays responsive to sequential movement detected at the seats of a seating venue. While the sounds are preferably musical instrument sounds, other sounds and special effects may be broadcast. As used herein, the term “seating venue” is used to indicate a place having a plurality, preferably at least 100, seats, such as a stadium, arena, concert hall, theater or auditorium. The term “seat” is used herein to include a support designed for a single person having arm rests on either side, whether formed as a free standing structure or formed integrally with other such supports, as well as benches which do not have armrests or other similar structures. The term “musical instrument sound” is used to indicate one or more sounds of a musical instrument, whether electronically created or prerecorded, including stringed instruments, percussion instruments, wind instrument, electronic instruments, and keyboard instruments.

In one embodiment, the movement of a portion of a movable seat or the movement of participants in each designated sound trigger, e.g. seating section of a stadium, is linked to a sound system such that sequential movement of the seats and/or participants at different sound triggers directly results in the sequential broadcast of different sounds which are generated in response to such movement. With the present invention, by coordinating the movement of the seats/people in different seats and/or seating sections, coordinated musical melodies can be broadcast within the arena. The melodies can be a short series of notes or, with proper coordination, can comprise longer, more complicated musical compositions.

Various embodiments of the present invention utilize sensors to detect relative movement of different components of a seat or to detect movement of a person proximate a seat. The sensors can comprise contact switches on portions of the seats, proximity switches, motion detectors, pressure switches, cameras, or other devices capable of detecting movement, preferably a major movement of a participant in the area of, i.e. proximate, a seat including movement relative to a seat or movement of one or more portions of a seat. As used herein, the term “major movement” means a movement of greater than twelve inches of a portion of the torso or a limb of a participant and includes the movement from a sitting to a standing position and vice versa. The term “major movement” does not include measurement of body condition such as heart beat, pulse, blood pressure, breathing, and facial expressions. Upon sensing movement, the sensor sends a signal, which is linked either directly or indirectly to a signal interface/computer processor in a broadcast system.

One preferred embodiment utilizes sensors on movable seats of the type commonly provided in an arena or stadium which traditionally comprise a base which is pivotally movable relative to the backrest. The sensors can either detect movement of portions of a seat relative to other portions of a seat, or can detect movement of a person proximate that seat. For example, suitable sensors can comprise contact switches which will sense the contact between a backrest and base of a movable seat, non-contact switches, accelerometers, proximity sensors, orientation sensors, proximity switches which detect movement of seat components in and out of preset ranges, motion detectors, pressure switches, electric eyes, cameras, or other devices capable of detecting motion of one or more participants, or one or more portions of the seat. The signals generated by the sensors are differentiated, at least by the time they get to the signal interface/computer processor, so that the signal interface/computer processor can differentiate between signals emanating from different seats, subgroups of seats, and/or stadium sections. According to this embodiment, the sensors detect movement, or major movement, and generate a detection signal responsive to the detected movement. The sensors are linked, e.g. wirelessly linked, to receivers which receive signals, e.g. using a Bluetooth technology such as low energy Bluetooth 4.0, which are forwarded to a broadcast device.

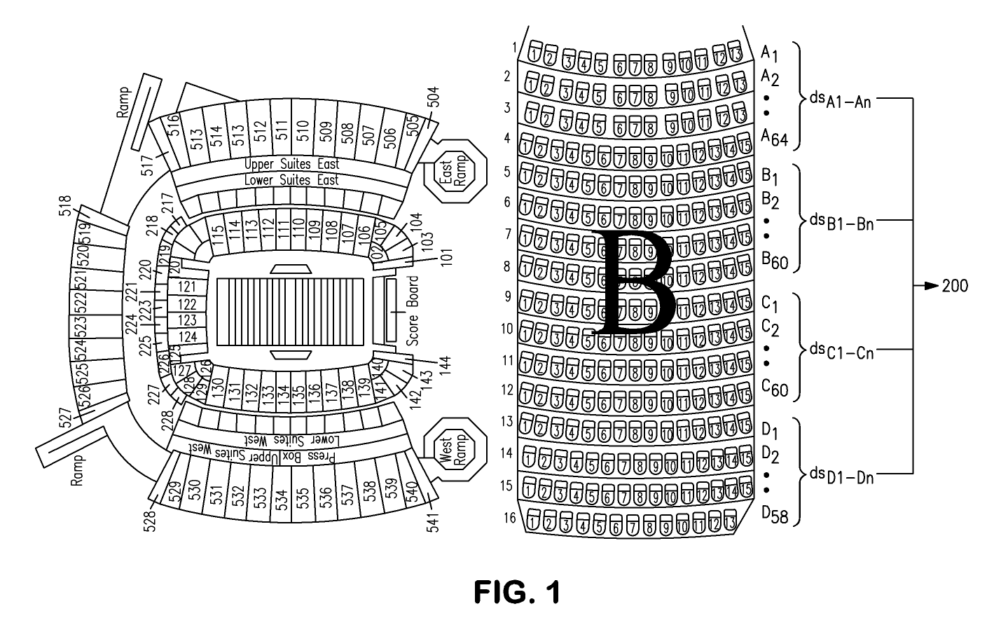

FIG. 1 generally illustrates one embodiment of the invention wherein a stadium entertainment system comprises thousands of seats in a football stadium. The illustration on the left of FIG. 1 is a football stadium comprising, for example 60,000 seats. A portion of one section, designated section B, is enlarged. This section comprises, for purposes of illustration, 232 seats arranged in 16 rows. In FIG. 1, the top 4 rows containing 54 seats is designated as sound trigger “a” with each seat having a designation a1, a2, . . . a54. Similarly the next 4 rows of seats which contain 60 seats is designated as distinct sound trigger “b” with each seat having its own designation namely b1, b2, . . . b60. A third sound trigger comprises 60 seats in the next 4 rows which are designated as third sound trigger “c” with each seat having a designation c1, c2, . . . c60. The bottom 4 rows of seats comprising 58 seats is designated as sound trigger “d” with each seat having individual designation namely, d1, d2, . . . d58. Movement of seats within one of the designated sound triggers is detected by sensors (not shown in FIG. 1) which generate detection signals, referred in FIG. 1 as “ds” with a designation for the specific seat such that the detection signal for seat a1 is designated dsₐ₁. The detection signals are transmitted via hardwire or wirelessly, either directly or through a series of appropriate relays, repeaters or the like as desired, to a broadcast system 200. Depending on the type of sensors used, the signals sensed at seats within a given sound trigger may not be differentiated when they leave the sensor, but are differentiated by the time they get to the signal interface/computer processor. For example, when simple contact switches are used, the resulting signals from a single sound trigger may initially be directed to a hub whose identity can be determined by the signal interface/computer processor in order to differentiate these signals from signals emanating from a different sound trigger.

According to a preferred embodiment and with reference to FIG. 1, certain parameters are preferably set to control the broadcast of sound signals. For example, a minimum percentage of participants in a given sound trigger must move in a detectable manner and preferably must do so within a preprogrammed time window, in order to cause a corresponding sound to be broadcast. With reference to FIG. 1, if the minimum percentage of participating participants is set at 50% by suitable inputs into a computer processor namely, broadcast device, and if a time window was set at 2.5 seconds, then only if these parameters are met will the sound which has been assigned to sound trigger “a” be broadcast. Therefore, even if the entertainment system is activated during the play of a football game, if a number of participants stand up and down for various reasons, no sound will be generated unless at least 27 of the participants in sound trigger “a” stand up within 2.5 second of each other (Of course, it is within the scope of the present invention to turn off the entertainment system when such broadcasts are not desired). Similarly, in sound trigger “b”, if the same parameters had been set, the sound assigned to sound trigger “b”, which is different from the sound assigned to sound trigger “a”, will only be generated if 30 of the 60 participants move within 2.5 seconds of each other.

The disclosed systems generate sequential broadcasts of different sounds when the participants in one sound trigger move sequentially relative to the participants in other sound triggers. In this fashion different melodies can be played.

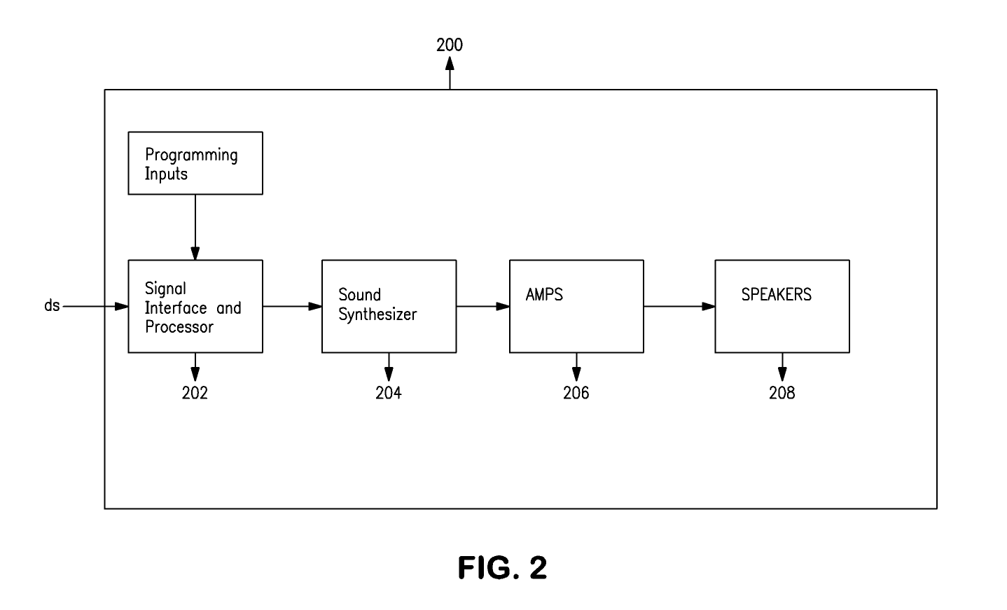

FIG. 2 generally illustrates an exemplary broadcast system of the present invention. As illustrated, the detection signals are received by a programmable signal interface which is designed to recognize the specific signals received, determine whether the signals fall within any prescribed parameters, such as those described below. The programmable signal interface has been programmed to assign the particular sound which will be ultimately broadcast as a result of the detection signal received from each sound trigger. For example, detection signals from sound trigger “a” may generate a sound corresponding to one key on a piano while detection signals from sound trigger “b” will result in the generation of sound corresponding to a second key on a piano. From the present description and FIG. 1 it will be appreciated that if each sound trigger has approximately 60 seats, then a stadium comprising 60,000 seats has the ability to provide 1,000 different sound triggers allowing for a very wide range of musical sounds and the performance of a wide range of musical compositions.

As illustrated in FIG. 2 signal interface/computer processor 202 is preferably programmable to set desired parameters. Programming inputs, applied via a keyboard or similar user interface are used to assign which sounds are ultimately broadcast upon receipt of detection signals from each sound trigger. Additionally, parameters such as requiring a certain number or percentage of detection signals to emanate from a given sound trigger in order for any corresponding sound to be generated, can be set as a predetermined parameter. The signals leaving signal interface/computer processor 202 may, for example, be digitized MIDI signals which are sent to a sound synthesizer 204 which in turn sends suitable signals to amplifiers 206 and ultimately to stadium speakers 208. FIG. 2 is exemplary and can be replaced with other broadcast devices. It is desirable to utilize existing sound equipment at a large seating venue to the extent possible to minimize cost.

If wireless sensors are utilized, a plurality of receivers are preferably positioned at various locations around the stadium, particularly if the signal broadcast range of the sensors is limited. In order to allow the signal interface/computer processor to differentiate between signals emanating from different sound triggers, signals from different sound triggers are differentiated. According to preferred embodiments, each of the sensors within a sound trigger is also differentiated in order to allow the implementation of other parameters described below.

A sound trigger may comprise one or a plurality of seats, for example, ten, twenty, fifty, one hundred, two hundred, or more seats or all of the seats in any pre-designated seating section of the seating venue. The seats of a sound trigger are preferably, but not necessarily, adjacent to each other in at least one direction, e.g., forwardly, rearwardly or side-by-side. The seating venue comprises a plurality of sound triggers, preferably at least 10 sound triggers, more preferably at least 50 sound triggers, and most preferably at least 100 or 200 sound triggers.

As noted above, the systems preferably comprises at least one programmable computer processor with at least one user interface, e.g., a keyboard and screen, which allows a system operator to change and/or program operating parameters such as: which seats form which sound triggers, what audio and/or video is broadcast in response to the detection signals received from specific sound triggers, the volume of the broadcast, any desired correspondence between the number of detection signals received from a given sound trigger and the volume of the resulting broadcast(s), any desired degree of muting or decreasing of the volume of a broadcast resulting from detection signals received from outside of one or more predetermined time ranges or sequences. If one or more participants are suspected of intentionally interfering with a broadcast, signals from the specific seats of those participants or from the sound trigger in which those seats are assigned can be nullified. Unintentional errant signals can also be nullified. The signal interface/computer processor receives the detection signals or input from signal receivers for the audio/video broadcasting system.

Thus, movement detected at each sound trigger comprising at least one but most preferably a plurality of seats, will result in the generation of a first sound, e.g., when the bases of those seats are moved relative to their respective backrests. Movement of a participant or movement of a portion of a seat in different sound triggers of seats results in the generation of different sounds. For example, eighty-eight different subgroups of seats (sound triggers) in a stadium can be linked to a broadcast system which broadcasts sounds corresponding to each of the sounds generated by striking the eighty-eight keys on a standard piano. The actual sounds which are broadcast as a result of the signals generated by movement detected at the seats can be any of various sounds, can correspond to notes creatable by various musical instruments, can each comprise multiple sounds such as several drum beats or guitar chords, or other storable or recordable sounds or video. In this manner, the coordinated, sequential movement at a plurality of sound triggers in a predetermined sequence is detected and directly used to generate music or other sequential sound effects, preferably over a pre-existing stadium broadcast system.

The entertainment systems disclosed allow for growth and development of the level of sophistication of the participants. For example, with a group of beginners, the seat numbers or section numbers corresponding to each sound trigger can be displayed on a large video display in a manner which provides the participants in each of the sound triggers with some notice as to when they should move, e.g. stand up. Standing up is presently considered the preferred movement. For example, if section “206” of a stadium comprises a single sound trigger, the number “206” can be displayed on a large video screen initially in one color such as red for 5 seconds, then change to yellow for 3 seconds, and then change to green indicating that the people in section “206” should stand-up to generate detection signals. In this manner, beginners can receive visible prompts for when they should stand-up or otherwise move. Such prompts can be provided in other manners, such as downloadable smart phone applications can be provided which will determine the position of participants within a seating venue and provide countdowns or early warnings for when certain sound triggers should move. In this manner, without much participant training, the participants of a stadium become active members in causing the broadcast of musical compositions. The audio and/or visual broadcasts can be used for general entertainment, for cheering on one or more teams, or for other desired purposes.

Alternatively, an individual can act as a conductor, e.g., by standing in the middle of the stadium and pointing to or otherwise indicating, e.g. by illuminating, the sections wherein the participants will either physically move relative to their seats, e.g., stand up or sit down, or will move a portion of their seats. For example, a participant may decide to stand in front of his seat while simply raising or lowering the base relative to the backrest at the desired times.

According to another aspect of the present invention, the signal interface/computer processor is programmed so that if the signal interface/computer processor receives a continuous stream of said detection signals indicating the continued movement of a portion of the seat or the continued movement of a person at a seat, a stream of corresponding signals are sent to cause the continuous play of that particular corresponding sound.

According to another embodiment, the processor calculates the number of seats in a subgroup which are moved and then sends signals to suitable amplification devices such that the volume of the sound broadcast will correspond to the number of seats at which movement was detected. The degree of correspondence between the volume of the broadcast and the number of seats at which movement was detected is preferably programmable so the correspondence is not necessarily one-to-one, and can be less than or greater than one-to-one.

According to another embodiment, the sequential movement sensed at the discrete sound triggers will be detected and broadcast in the form of visible signals, such as lights or visual displays on a screen.

Various groups of attendees at a stadium can participate in the creation of different musical compositions comprising a long sequence of distinct musical instrument sounds, e.g. 300 sounds, in a competition. The signal interface/computer controller is programmable to activate subgroups i.e. less than all of the sound triggers within a seating venue, wherein each of the subgroups has a plurality of sound triggers. This permits competition among different groups of fans, each comprising a plurality of sound triggers. Fans of one team can compete with fans of an opposing team, e.g., to see who can generate the most pleasing melodies. In order to prevent unruly participants from sending signals during a performance by other competitors, the processor can be programmed to turn off or ignore signals emanating from non-performing participants at any given time. In another embodiment, the movement of seats in sections which are “out of tune” or are moved at undesired times or outside of a permitted time range which has been programmed into the computer processor are entirely nullified or have their volume significantly reduced relative to the volume of sounds broadcast by sections which are desired to be moved at a given time. In this manner, the undesired effects of uncooperative participants can be minimized or negated entirely, as desired, by programming.

The processor is also preferably programmable to only send certain signals to the broadcast system, for example, signals corresponding to a predetermined musical arrangement. In this embodiment, the generation of the desired broadcast still requires the receipt of requisite detection signals emanating from predetermined subgroups of seats at predetermined times. Therefore, while errant sounds are not broadcast according to this embodiment, receipt of detection signals by the signal interface at a time outside of a predetermined range or the receipt of insufficient signals would result in less than all of the notes of the musical composition being broadcast. The number of signals received can also be coordinated with the volume, intensity or amount of audio or video broadcast displayed by programming the computer processor.

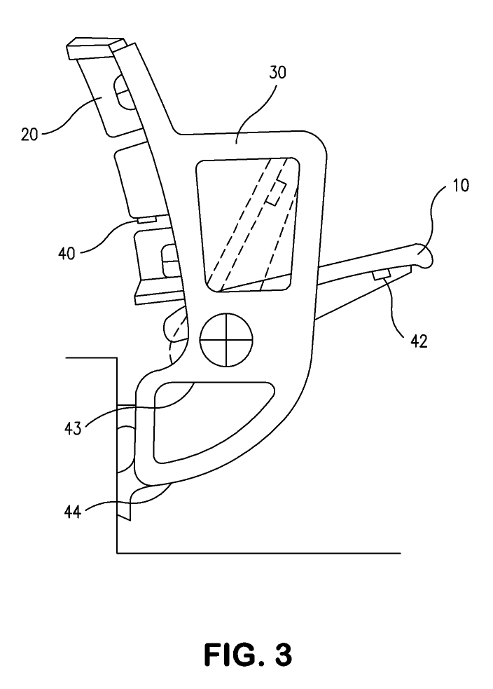

FIG. 3 illustrates a stadium seat comprising a base 10, backrest 20, armrest 30, armrest supports 35, and proximity sensors 40 and 42. Base 10 is pivotally movable relative to the segmented backrest 20 in a conventional fashion. Proximity sensors 40 and 42 detect when the sensors 40/42 are within a certain predetermined range of each other or are outside a predetermined range and send a detection signal in response thereto. While a signal is preferably sent wirelessly, in this illustrated embodiment electrical leads 43,44 are connected to proximity sensors 40, 42 respectively and transmit the signals to a remote signal interface/computer controller.

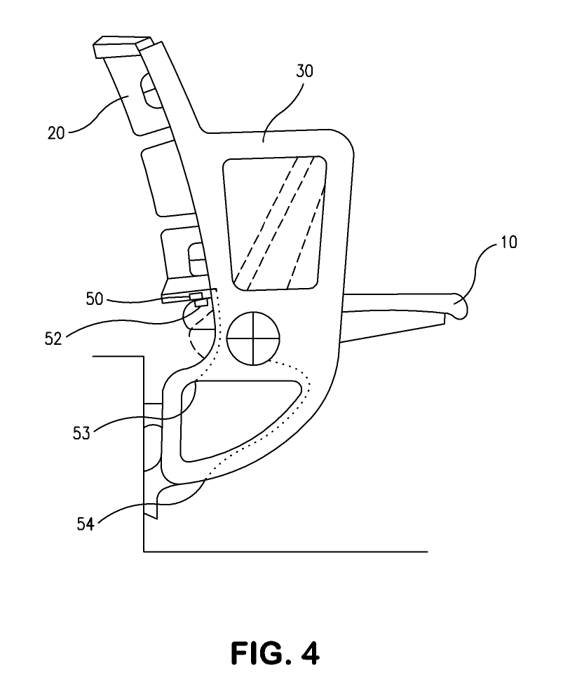

FIG. 4 illustrates a stadium seat comprising a base 10, backrest 20, armrest 30, and electrical contacts 50 and 52. According to this embodiment, the sensors are contact sensors which transmit a signal through conductors 53, 54 to indicate movement of base 10 relative to backrest 20. The signal is sent to a signal interface/computer processor.

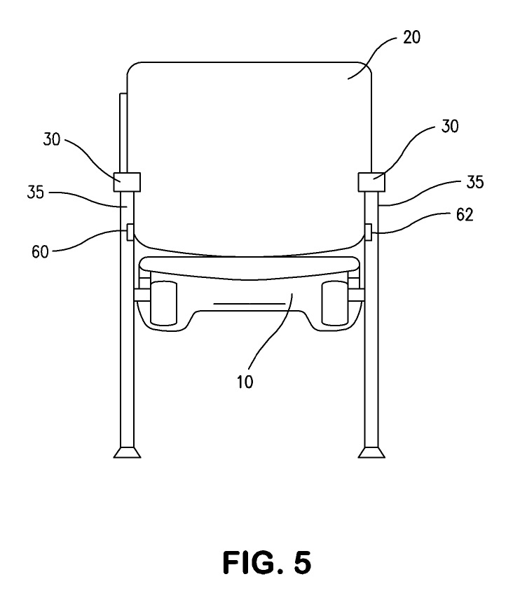

FIG. 5 illustrates an alternative sensor arrangement wherein a stadium seat comprising a base 10, backrest 20, armrest 30, armrest supports 35 and electric eye component 60 and 62 on armrest supports 35. Movement of base 10 and/or the presence of a person between electric eye component 60 and 62 will block the beam and provide a detection signal.

The computer processor can perform one or more desired functions, such as determining the volume of the audio and/or video to be broadcast, tabulating the number of signals received from each section, reducing or muting the discernible broadcast resulting from signals outside of a desired range, etc.

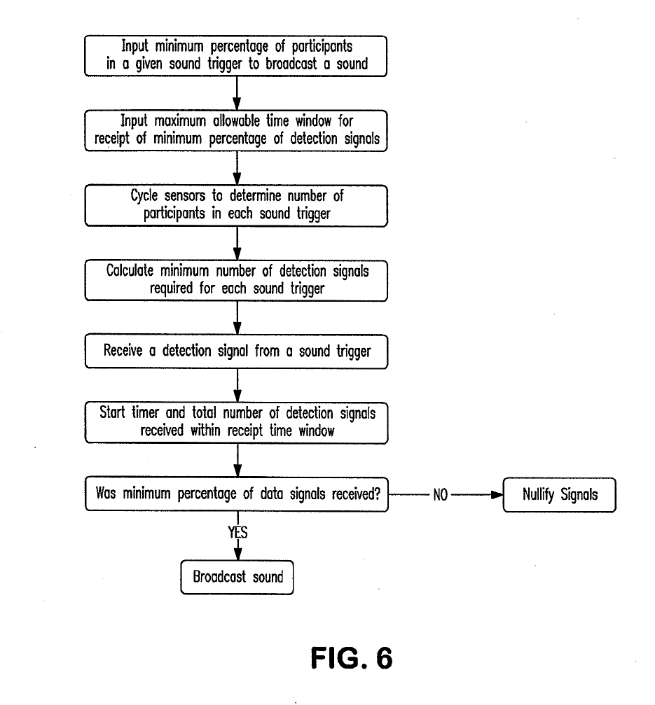

FIG. 6 is a flow chart of an algorithm which can be programmed into the signal interface/computer processor in one preferred embodiment which utilizes sound triggers comprising a number of participants. According to this preferred embodiment, in order to cause the broadcast of a sound, e.g. a musical note, the number of participants in a sound trigger is determined and at least a minimum percentage of the participants in a given sound trigger must cause corresponding sensors to generate detection signals in order for a sound to be generated. The specific percentage of participants from a given sound trigger which are required to ultimately cause a sound broadcast can be set by the system operator and is programmable into the computer processor. Similarly, a time window is established for purposes of counting detected signals. For example, if the minimum percentage had been set at 50% of the participants within a sound trigger, then 50% of such participants must cause detection signals to be generated within a certain time window, for example 3 seconds. These parameters are designed to prevent the unintended broadcast of sounds if a participant moves in a detected manner to go purchase some food, use a restroom, etc. According to the algorithm illustrated in the flowchart of FIG. 6, initially a system operator or other authorized person inputs the minimum percentage of participating participants in a given sound trigger required to broadcast a sound. Secondly, the maximum allowable time window for receipt of the minimum percentage of detection signals is also input into the computer processor. All sensors in each sound trigger are preferably cycled in order to determine the number of participants in each sound trigger. The minimum number of detection signals for each sound trigger is then calculated and stored. Then, when a detection signal is received from a sound trigger a timer is started and the signal interface/computer processor totals the number of detection signals as they are received. Next the percentage of detection signals received is calculated. If the minimum required percentage is reached then the sound is broadcast. Until the minimum number of detection signals required for each sound trigger is received, the processor continues to add the number of detection signals received until the maximum allowable time has expired. If the minimum percentage of detection signals was received before the expiration of the allowable time window then the corresponding sound is broadcast. If the minimum percentage of detection signals was not received during the maximum allowable time window, then the signals are nullified and the sound does not broadcast.

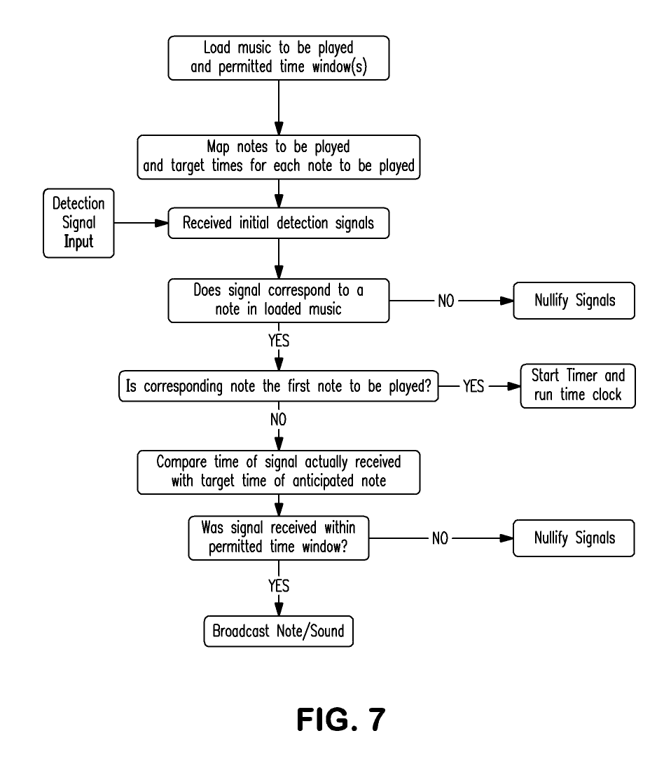

FIG. 7 is a flowchart of an algorithm that can be used to eliminate errant signals. The top box in FIG. 7 indicates a programming input into the signal interface/computer processor of one embodiment. In this embodiment, a musical composition is loaded into the computer processor and a time window is input to set a time range during which any given note, musical instrument sound, sound effect, or the like can be played. For example, the time window may be set at 5 seconds before or after the anticipated time of the note being played. Shorter or longer time windows can be programmed into the computer processor depending upon the skill level of the participants. After the musical composition has been input and the time window has been set, the computer processor maps the notes to be played and the target times for each note to be played. When the participants start to move in a detected manner, the signal interface/computer processor receives a detection signal corresponding to a note or other sound. The computer processor compares this note first determine whether it is in the composition and secondly whether it is the first note of the pre-loaded musical composition. If the signal received corresponds the first note in the musical composition loaded into the computer processor, then a timer is initiated. If the note is not a note in the composition or the indicated first note of the musical composition, the signal and, therefore, the corresponding note are nullified. After the clock has been started subsequent notes are compared to the mapping and the target times for such additional notes. Suitable precautions are taken to prevent the restarting of the clock if the original note is replayed during the musical composition. As each signal corresponding to a note is received, the system compares the time of receipt of the signal with the target time of the anticipated note to be played. If the signal was received within the permitted time window, then the note or other sound is broadcast. If the signal is not received within the permitted time frame then the signal is nullified and the note is not broadcast.

With proper coordination, participants can cause the systems of the present invention to broadcast a complicated musical composition. While the present invention has been described in relation to use at a stadium, the present invention can also be utilized with different seating venues such as at a live performance theater, a movie theater, or in a lecture hall.

While active participation is desired, it is not necessary for all seats in a given subgroup or section to move in order to activate or operate the system described herein.

According to other embodiments, the broadcast caused by the participants in the sound triggers can be supplemented with other sound and/or video.

According to an alternative embodiment of the present invention, music is played and the participants strive to move in sync with the notes and/or sounds of the music. This embodiment provides a method of exercise and requires the participants to be aware of which sound(s) corresponds to their movement, and to anticipate when that sound is being broadcast. A video screen can provide an indication of how well the participants moved in relation to the broadcast music. This embodiment preferably comprises a seating venue comprising as least one hundred seats, a plurality of said seats designated as a plurality of distinct sound triggers, sensors which detect movement at said (designated seats) and generate detection signals in response to the detection of movement at each of said sound triggers; a sound system which broadcasts a plurality of different sounds to said seating venue; said different sounds have a predetermined correspondence with a corresponding plurality of said detection signals; a correlation device which receives the detection signals and provides an indication of said different sounds and determines the correlation between said broadcast sounds and detection signals. Preferably, this embodiment also comprises a video screen to which the correlation device is operatively linked to provide a visible indication of the correlation to the participants and/or others.

1. An entertainment system comprising:
a seating venue comprising a plurality of seats;
a plurality of said seats designated as a plurality of distinct sound triggers;
sensors which detect movement at said sound triggers and generate detection signals in response to the detection of movement at each of said sound triggers; and
a broadcast device operatively linked to said sensors which receives said detection signals and broadcasts different sounds in response to said discrete detection signals.

2. An entertainment system according to claim 1 wherein said broadcast device broadcasts said different sounds sequentially in response to the sequential receipt of said detection signals.

3. An entertainment system according to claim 1 wherein each sound trigger comprises a plurality of seats.

4. An entertainment system according to claim 1 wherein each sound trigger comprises at least 5 seats.

5. An entertainment system according to claim 1 wherein each sound trigger comprises at least 25 seats.

6. An entertainment system according to claim 1 wherein each sound trigger comprises at least 100 seats.

7. An entertainment system according to claim 1 comprising a sensor for each of said designated seats.

8. An entertainment system according to claim 1 wherein said seats are movable seats and said sensors detect relative movement between relatively movable portions of said seats.

9. An entertainment system according to claim 1 wherein said sensors detect a movement of a person proximate a seat.

10. An entertainment system according to claim 1 wherein said sensors detect a major movement of a person proximate a seat.

11. An entertainment system according to claim 1 wherein said different sounds comprises a different musical tone.

12. An entertainment system according to claim 1 wherein said different sounds comprises different musical instrument sounds selected from the group consisting of sounds typically generated by stringed instruments, percussion instruments, and wind instruments.

13. An entertainment system according to claim 1 further comprising a least one video display.

14. An entertainment system according to claim 13 further comprising a video prompter which generates video images on said video display corresponding to sound triggers and a desired sequence of detection signals to prompt sequential movement of participants at said designated seats.

15. An entertainment system according to claim 1 comprising at least 10 distinct sound triggers.

16. An entertainment system according to claim 1 comprising at least 25 distinct sound triggers.

17. An entertainment system according to claim 1 comprising at least 100 distinct sound triggers.

18. An entertainment system comprising:
a seating venue comprising at least one hundred seats;
a plurality of said seats designated as a plurality of distinct sound triggers each comprising a plurality of seats;
sensors which detect relative movement of a portion of a seat or a predetermined movement of a person at said sound triggers and generate signals in response to the detection of movement at said sound triggers; and
a broadcast device operatively linked to said sensors which receives said detection signals and broadcasts different sounds in response to said discrete detection signals.

19. An entertainment system according to claim 18 wherein said broadcast device broadcasts said different sounds sequentially in response to the sequential receipt of said detection signals.

20. An entertainment system according to claim 18 wherein each sound trigger comprises at least 5 seats.

21. An entertainment system according to claim 18 wherein each sound trigger comprises at least 10 seats.

22. An entertainment system according to claim 18 wherein each sound trigger comprises at least 25 seats.

23. An entertainment system according to claim 18 wherein each sound trigger comprises at least 100 seats.

24. An entertainment system according to claim 18 comprising a sensor for each of said designated seats.

25. An entertainment system according to claim 18 wherein said seats are movable seats and said sensors detect relative movement between relatively movable portions of said seats.

26. An entertainment system according to claim 18 wherein said detectors detect movement of a person at a seat.

27. An entertainment system according to claim 18 wherein said detectors detect a major movement of a person at a seat.

28. An entertainment system according to claim 18 wherein each of said different sounds comprises a different musical tone.

29. An entertainment system according to claim 18, wherein each of said different sounds comprises a different musical instrument sound selected from the group consisting of sounds typically generated by stringed instruments, percussion instruments, and wind instruments.

30. An entertainment system according to claim 18 further comprising a least one video display.

31. An entertainment system according to claim 30 further comprising a video prompter which generates video images on said video display corresponding to sound triggers and a desired sequence of detection signals to prompt sequential movement of participants at said designated seats.

32. An entertainment system according to claim 18 comprising at least 10 distinct sound triggers.

33. An entertainment system according to claim 18 comprising at least 25 distinct sound triggers.

34. An entertainment system according to claim 18 comprising at least 100 distinct sound triggers.

35. An entertainment system according to claim 18 comprising at least 200 distinct sound triggers.

36. A stadium sound system comprising:
at least five thousand seats;
a plurality of said seats designated as a plurality of distinct sound triggers;
sensors which detect movement at said sound triggers and generate detection signals in response to the detection of sequential movement at each of said sound triggers; and
a broadcast device operatively linked to said sensors which receives said detection signals and sequentially broadcasts different sounds in response to each of said detection signals initiated at different sound triggers.

37. An entertainment system comprising:
a seating venue comprising as least one hundred seats;
a plurality of said seats designated as a plurality of distinct sound triggers;
sensors which detect movement at said designated seats and sequentially generate detection signals in response to the sequential detection of movement at each of said sound triggers; and
a sound system which sequentially broadcasts a plurality of different sounds to said seating venue;
said different sounds have a predetermined correspondence with a corresponding plurality of said detection signals;
a correlation device which receives said detection signals and an indication of said different sounds and determines the correlation between said broadcast sounds and detection signals

38. An entertainment system according to claim 37 further comprising a video screen, said correlation device is operatively linked to said video screen and provides a visible indication of said correlation.

39. A method of providing participatory entertainment comprising the steps of:
providing a plurality of seats designated into a plurality of sound triggers;
providing sensors which detect participant movement at said sound triggers and generate detection signals indicative of detected movement; and
providing a broadcast system which receives said detection signals and broadcasts different predetermined discernible signals in response to the receipt of signals from different sound triggers.

40. A method according to claim 39 further comprising
the step of changing the discernible signals which are broadcast in response to the receipt of signals from at least one sound trigger.

41. A method according to claim 39 further comprising
the step of changing the discernible signals which are broadcast in response to the receipt of detection signals received from a plurality of said sound triggers.

42. A method according to claim 39 wherein said discernible signal comprises a musical instrument sound.

43. A method according to claim 37 wherein said discernible signals comprises a video display.
